(19) United States
(12) Patent Application Publication
(10) Pub. No.: US 2012/0127183 A1
(43) Pub. Date: May 24, 2012

(54) Distribution Processing Pipeline and Distributed Layered Application Processing

(75) Inventors: Stanislav Vonog, San Francisco, CA (US); Nikolay Surin, San Francisco, CA (US); Tara Lemmey, San Francisco, CA (US)

(73) Assignee: NET POWER AND LIGHT, INC., San Francisco, CA (US)

(21) Appl. No.: 13/279,242

(22) Filed: Oct. 21, 2011

Related U.S. Application Data
(60) Provisional application No. 61/405,601, filed on Oct. 21, 2010.

(51) Int. Cl. G06T 1/20; G06F 15/16

(52) U.S. Cl. 345/506; 709/231; 709/201

(57) ABSTRACT

The present invention contemplates a variety of improved methods and systems for distributing different processing aspects of layered application, and distributing a processing pipeline among a variety of different computer devices. The system uses multiple devices resources to speed up or enhance applications. In one embodiment, application layers can be distributed among different devices for execution or rendering. The teaching further expands on this distribution of processing aspects by considering a processing pipeline such as that found in a graphics processing unit (GPU), where execution of parallelized operations and/or different stages of the processing pipeline can be distributed among different devices. There are many suitable ways of describing, characterizing and implementing the methods and systems contemplated herein.

### PRIORITY CLAIM

This application claims the benefit of U.S. Provisional Application No. 61/405,601 under 35 U.S.C. 119(e), filed Oct. 21, 2010, the contents of which is incorporated herein by reference.

### BACKGROUND OF INVENTION

1. Field of Invention

The present teaching relates to distributing different processing aspects of a layered application, and distributing a processing pipeline among a variety of different computer devices.

2. Summary of the Invention

The present invention contemplates a variety of improved methods and systems for distributing different processing aspects of layered applications, and distributing a processing pipeline among a variety of different computer devices. The system uses multiple devices resources to speed up or enhance applications. In one embodiment, an application is a composite of layers that can be distributed among different devices for execution or rendering. The teaching further expands on this distribution of processing aspects by considering a processing pipeline such as that found in a graphics processing unit (GPU), where execution of parallelized operations and/or different stages of the processing pipeline can be distributed among different devices. In some embodiments, a resource or device aware network engine dynamically determines how to distribute the layers and/or operations. The resource-aware network engine may take into consideration factors such as network properties and performance, and device properties and performance. There are many suitable ways of describing, characterizing and implementing the methods and systems contemplated herein.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a system architecture for composing and directing user experiences;

FIG. 2 is a block diagram of an experience agent;

FIG. 3 is a block diagram of a sentio codec;

FIGS. 4-6 illustrate several example experiences involving the merger of various layers including served video, video chat, PowerPoint, and other services;

FIGS. 7-9 illustrate a demonstration of an application powered by a distributed processing pipeline utilizing the network resources such as cloud servers to speed up the processing;

FIG. 10 illustrates a block diagram of a system for providing distributed execution or rendering of various layers associated with an application;

FIG. 11 illustrates a block diagram of a distributed GPU pipeline;

FIG. 12 illustrates a block diagram of a multi-stage distributed processing pipeline;

FIG. 13 is a flow chart of a method for distributed execution of a layered application.

FIG. 14 illustrates an overview of the system, in accordance with an embodiment.

FIG. 15 illustrates distributed GPU pipelines, in accordance with embodiments.

FIG. 16 illustrates a structure of device or GPU processing unit, in accordance with an embodiment.

### DETAILED DESCRIPTION OF THE INVENTION

The following teaching describes how various processing aspects of a layered application can be distributed among a variety of devices. The disclosure begins with a description of an experience platform providing one example of a layered application. The experience platform enables a specific application providing a participant experience where the application is considered as a composite of merged layers. Once the layer concept is described in the context of the experience platform with several different examples, the application continues with a more generic discussion of how application layers can be distributed among different devices for execution or rendering. The teaching further expands on this distribution of processing aspects by considering a processing pipeline such as that found in a graphics processing unit (GPU), where execution of different stages of the processing pipeline can be distributed among different devices. Multiple devices' resources are utilized to speed up or enhance applications.

The experience platform enables defining application specific processing pipelines using the devices that surround a user. Various sensors and audio/video output (such as screens) and general-purpose computing resources (such as memory, CPU, GPU) are attached to the devices. Devices have varying data; such as photos on the iPhone, videos on a network attached storage with limited CPU. The software or hardware application-specific capabilities, such as gesture recognition, special effect rendering, hardware decoders, image processors, and GPUs, also vary. The system allows utilizing platforms with general-purpose and application-specific computing resources and sets up pipelines to enable devices to achieve task beyond the devices' own functionality and capability. For example, a software such as 3DS Max may run on an operating system (OS) that is incompatible. Or a hardware-demanding game such as Need For Speed may run on a basic set top box or an iPAD. Or an application may speed up unimaginably.

The system allows to set up pipelines with a lot of GPU/CPU available remotely over the network or to render parts of the experience using platform's services and pipelines. The system delivers that functionality as one layer in a multidimensional experience.

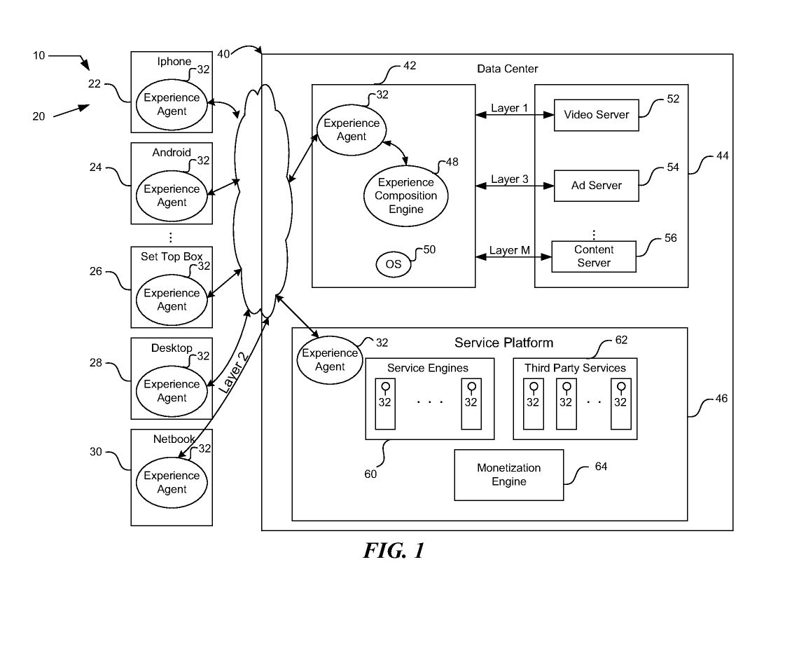

FIG. 1 illustrates a block diagram of a system 10. The system 10 can be viewed as an “experience platform” or system architecture for composing and directing a participant experience. In one embodiment, the experience platform 10 is provided by a service provider to enable an experience provider to compose and direct a participant experience. The participant experience can involve one or more experience participants. The experience provider can create an experience with a variety of dimensions, as will be explained further now. As will be appreciated, the following description provides one paradigm for understanding the multi-dimensional experience available to the participants. There are many suitable ways of describing, characterizing and implementing the experience platform contemplated herein.

In general, services are defined at an API layer of the experience platform. The services provide functionality that can be used to generate “layers” that can be thought of as representing various dimensions of experience. The layers form to make features in the experience.

By way of example, the following are some of the services and/or layers that can be supported on the experience platform.

Video—is the near or substantially real-time streaming of the video portion of a video or film with near real-time display and interaction.

Video with Synchronized DVR—includes video with synchronized video recording features.

Synch Chalktalk—provides a social drawing application that can be synchronized across multiple devices.

Virtual Experiences—are next generation experiences, akin to earlier virtual goods, but with enhanced services and/or layers.

Video Ensemble—is the interaction of several separate but often related parts of video that when woven together create a more engaging and immersive experience than if experienced in isolation.

Explore Engine—is an interface component useful for exploring available content, ideally suited for the human/computer interface in a experience setting, and/or in settings with touch screens and limited i/o capability

Audio—is the near or substantially real-time streaming of the audio portion of a video, film, karaoke track, song, with near real-time sound and interaction.

Live—is the live display and/or access to a live video, film, or audio stream in near real-time that can be controlled by another experience dimension. A live display is not limited to single data stream.

Encore—is the replaying of a live video, film or audio content. This replaying can be the raw version as it was originally experienced, or some type of augmented version that has been edited, remixed, etc.

Graphics—is a display that contains graphic elements such as text, illustration, photos, freehand geometry and the attributes (size, color, location) associated with these elements. Graphics can be created and controlled using the experience input/output command dimension(s) (see below).

Input/Output Command(s)—are the ability to control the video, audio, picture, display, sound or interactions with human or device-based controls. Some examples of input/output commands include physical gestures or movements, voice/sound recognition, and keyboard or smart-phone device input(s).

Interaction—is how devices and participants interchange and respond with each other and with the content (user experience, video, graphics, audio, images, etc.) displayed in an experience. Interaction can include the defined behavior of an artifact or system and the responses provided to the user and/or player.

Game Mechanics—are rule-based system(s) that facilitate and encourage players to explore the properties of an experience space and other participants through the use of feedback mechanisms. Some services on the experience Platform that could support the game mechanics dimensions include leader boards, polling, like/dislike, featured players, star-ratings, bidding, rewarding, role-playing, problem-solving, etc.

Ensemble—is the interaction of several separate but often related parts of video, song, picture, story line, players, etc. that when woven together create a more engaging and immersive experience than if experienced in isolation.

Auto Tune—is the near real-time correction of pitch in vocal and/or instrumental performances. Auto Tune is used to disguise off-key inaccuracies and mistakes, and allows singer/players to hear back perfectly tuned vocal tracks without the need of singing in tune.

Auto Filter—is the near real-time augmentation of vocal and/or instrumental performances. Types of augmentation could include speeding up or slowing down the playback, increasing/decreasing the volume or pitch, or applying a celebrity-style filter to an audio track (like a Lady Gaga or Heavy-Metal filter).

Remix—is the near real-time creation of an alternative version of a song, track, video, image, etc. made from an original version or multiple original versions of songs, tracks, videos, images, etc.

Viewing 360°/Panning—is the near real-time viewing of the 360° horizontal movement of a streaming video feed on a fixed axis. Also the ability to for the player(s) to control and/or display alternative video or camera feeds from any point designated on this fixed axis.

Turning back to FIG. 1, the experience platform 10 includes a plurality of devices 20 and a data center 40. The devices 12 may include devices such as an iPhone 22, an android 24, a set top box 26, a desktop computer 28, and a netbook 30. At least some of the devices 12 may be located in proximity with each other and coupled via a wireless network. In certain embodiments, a participant utilizes multiple devices 12 to enjoy a heterogeneous experience, such as using the iPhone 22 to control operation of the other devices. Multiple participants may also share devices at one location, or the devices may be distributed across various locations for different participants.

Each device 12 has an experience agent 32. The experience agent 32 includes a sentio codec and an API. The sentio codec and the API enable the experience agent 32 to communicate with and request services of the components of the data center 40. The experience agent 32 facilitates direct interaction between other local devices. Because of the multi-dimensional aspect of the experience, the sentio codec and API are required to fully enable the desired experience. However, the functionality of the experience agent 32 is typically tailored to the needs and capabilities of the specific device 12 on which the experience agent 32 is instantiated. In some embodiments, services implementing experience dimensions are implemented in a distributed manner across the devices 12 and the data center 40. In other embodiments, the devices 12 have a very thin experience agent 32 with little functionality beyond a minimum API and sentio codec, and the bulk of the services and thus composition and direction of the experience are implemented within the data center 40.

Data center 40 includes an experience server 42, a plurality of content servers 44, and a service platform 46. As will be appreciated, data center 40 can be hosted in a distributed manner in the “cloud,” and typically the elements of the data center 40 are coupled via a low latency network. The experience server 42, servers 44, and service platform 46 can be implemented on a single computer system, or more likely distributed across a variety of computer systems, and at various locations.

The experience server 42 includes at least one experience agent 32, an experience composition engine 48, and an operating system 50. In one embodiment, the experience composition engine 48 is defined and controlled by the experience provider to compose and direct the experience for one or more participants utilizing devices 12. Direction and composition is accomplished, in part, by merging various content layers and other elements into dimensions generated from a variety of sources such as the service provider 42, the devices 12, the content servers 44, and/or the service platform 46.

The content servers 44 may include a video server 52, an ad server 54, and a generic content server 56. Any content suitable for encoding by an experience agent can be included as an experience layer. These include well know forms such as video, audio, graphics, and text. As described in more detail earlier and below, other forms of content such as gestures, emotions, temperature, proximity, etc., are contemplated for encoding and inclusion in the experience via a sentio codec, and are suitable for creating dimensions and features of the experience.

The service platform 46 includes at least one experience agent 32, a plurality of service engines 60, third party service engines 62, and a monetization engine 64. In some embodiments, each service engine 60 or 62 has a unique, corresponding experience agent. In other embodiments, a single experience 32 can support multiple service engines 60 or 62. The service engines and the monetization engines 64 can be instantiated on one server, or can be distributed across multiple servers. The service engines 60 correspond to engines generated by the service provider and can provide services such as audio remixing, gesture recognition, and other services referred to in the context of dimensions above, etc. Third party service engines 62 are services included in the service platform 46 by other parties. The service platform 46 may have the third-party service engines instantiated directly therein, or within the service platform 46 these may correspond to proxies which in turn make calls to servers under control of the third-parties.

Monetization of the service platform 46 can be accomplished in a variety of manners. For example, the monetization engine 64 may determine how and when to charge the experience provider for use of the services, as well as tracking for payment to third-parties for use of services from the third-party service engines 62.

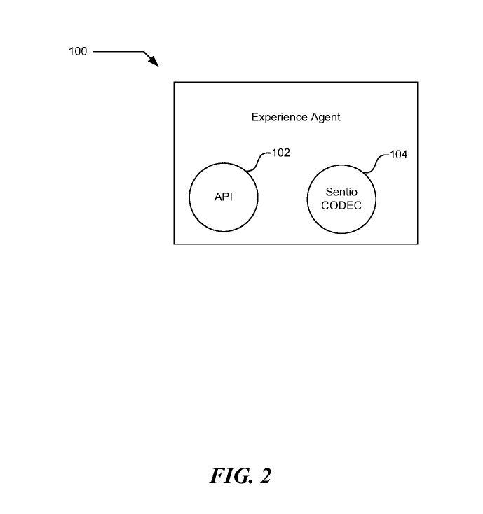

FIG. 2 illustrates a block diagram of an experience agent 100. The experience agent 100 includes an application programming interface (API) 102 and a sentio codec 104. The API 102 is an interface which defines available services, and enables the different agents to communicate with one another and request services.

The sentio codec 104 is a combination of hardware and/or software which enables encoding of many types of data streams for operations such as transmission and storage, and decoding for operations such as playback and editing. These data streams can include standard data such as video and audio. Additionally, the data can include graphics, sensor data, gesture data, and emotion data. (“Sentio” is Latin roughly corresponding to perception or to perceive with one's senses, hence the nomenclature “sensio codec.”)

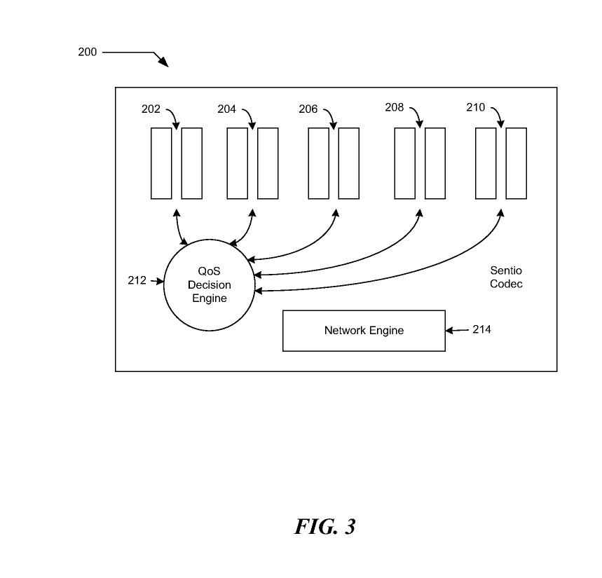

FIG. 3 illustrates a block diagram of a sentio codec 200. The sentio codec 200 includes a plurality of codecs such as video codecs 202, audio codecs 204, graphic language codecs 206, sensor data codecs 208, and emotion codecs 210. The sentio codec 200 further includes a quality of service (QoS) decision engine 212 and a network engine 214. The codecs, the QoS decision engine 212, and the network engine 214 work together to encode one or more data streams and transmit the encoded data according to a low-latency transfer protocol supporting the various encoded data types. One example of this low-latency protocol is described in more detail in Vonog et al.'s U.S. patent application Ser. No. 12/569,876, filed Sep. 29, 2009, and incorporated herein by reference for all purposes including the low-latency protocol and related features such as the network engine and network stack arrangement.

The sentio codec 200 can be designed to take all aspects of the experience platform into consideration when executing the transfer protocol. The parameters and aspects include available network bandwidth, transmission device characteristics and receiving device characteristics. Additionally, the sentio codec 200 can be implemented to be responsive to commands from an experience composition engine or other outside entity to determine how to prioritize data for transmission. In many applications, because of human response, audio is the most important component of an experience data stream. However, a specific application may desire to emphasize video or gesture commands.

The sentio codec provides the capability of encoding data streams corresponding with many different senses or dimensions of an experience. For example, a device 12 may include a video camera capturing video images and audio from a participant. The user image and audio data may be encoded and transmitted directly or, perhaps after some intermediate processing, via the experience composition engine 48, to the service platform 46 where one or a combination of the service engines can analyze the data stream to make a determination about an emotion of the participant. This emotion can then be encoded by the sentio codec and transmitted to the experience composition engine 48, which in turn can incorporate this into a dimension of the experience. Similarly a participant gesture can be captured as a data stream, e.g. by a motion sensor or a camera on device 12, and then transmitted to the service platform 46, where the gesture can be interpreted, and transmitted to the experience composition engine 48 or directly back to one or more devices 12 for incorporation into a dimension of the experience.

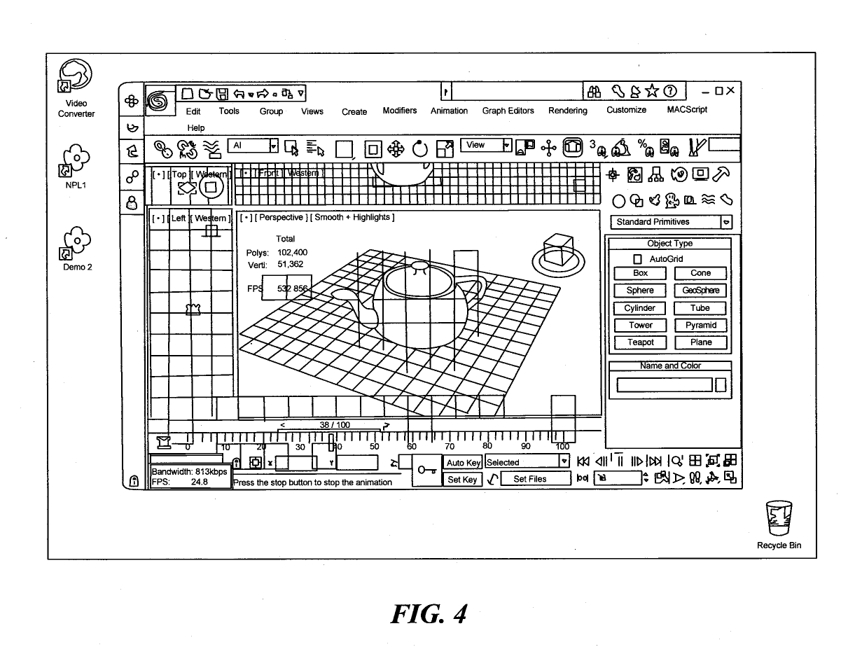

FIG. 4 provides an example experience showing 4 layers. These layers are distributed across various different devices. For example, a first layer is Autodesk 3ds Max instantiated on a suitable layer source, such as on an experience server or a content server. A second layer is an interactive frame around the 3ds Max layer, and in this example is generated on a client device by an experience agent. A third layer is the black box in the bottom-left corner with the text “FPS” and “bandwidth”, and is generated on the client device but pulls data by accessing a service engine available on the service platform. A fourth layer is a red-green-yellow grid which demonstrates an aspect of the low-latency transfer protocol (e.g., different regions being selectively encoded) and is generated and computed on the service platform, and then merged with the 3ds Max layer on the experience server.

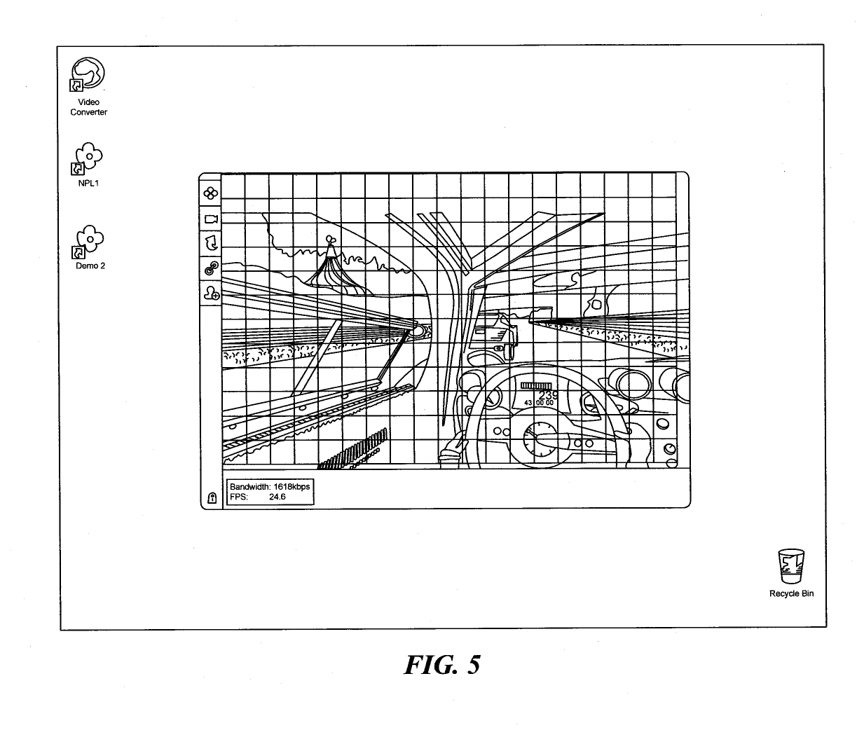

FIG. 5, similar to FIG. 4, shows four layers, but in this case instead of a 3ds Max base layer, a first layer is generated by piece of code developed by EA and called “Need for Speed.” A second layer is an interactive frame around the Need for Speed layer, and may be generated on a client device by an experience agent, on the service platform, or on the experience platform. A third layer is the black box in the bottom-left corner with the text “FPS” and “bandwidth”, and is generated on the client device but pulls data by accessing a service engine available on the service platform. A fourth layer is a red-green-yellow grid which demonstrates an aspect of the low-latency transfer protocol (e.g., different regions being selectively encoded) and is generated and computed on the service platform, and then merged with the Need for Speed layer on the experience server.

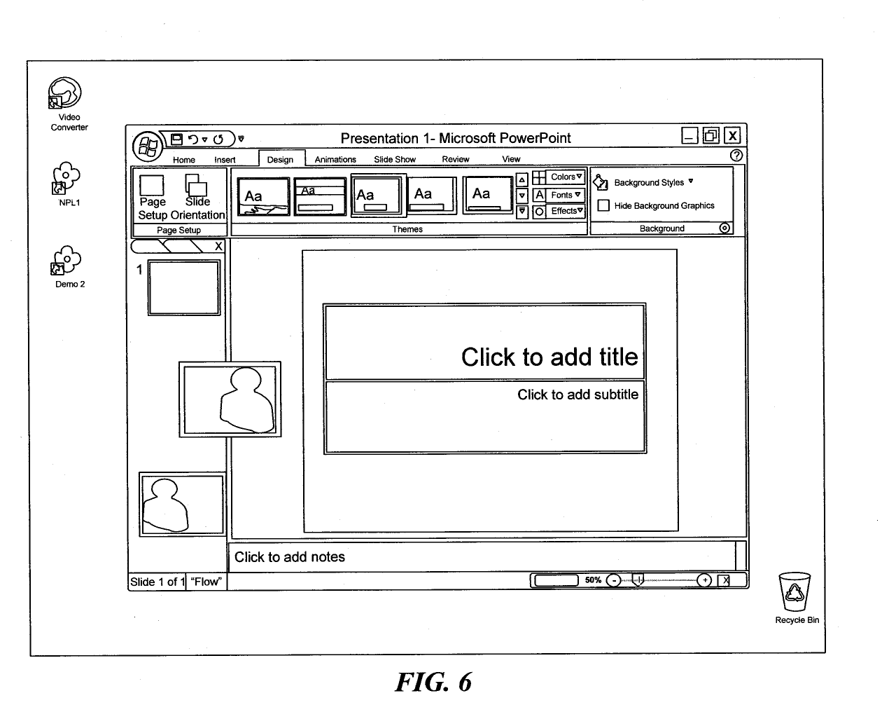

FIG. 6 demonstrates several dimensions available with a base layer generated by piece of code called Microsoft PowerPoint. FIG. 6 illustrates how video chat layer(s) can be merged with the PowerPoint layer. The interactive frame layer and the video chat layer can be rendered on specific client devices, or on the experience server

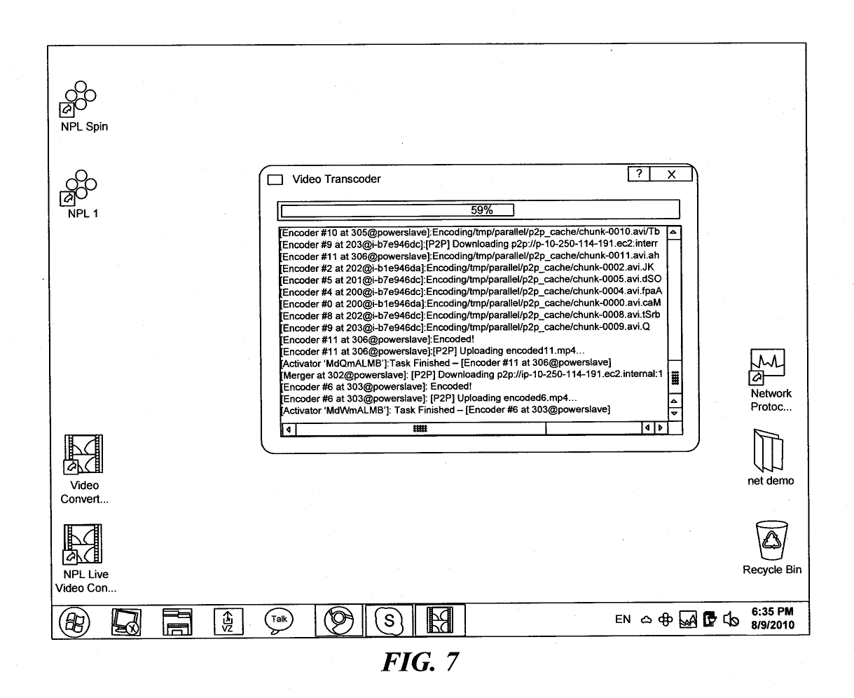

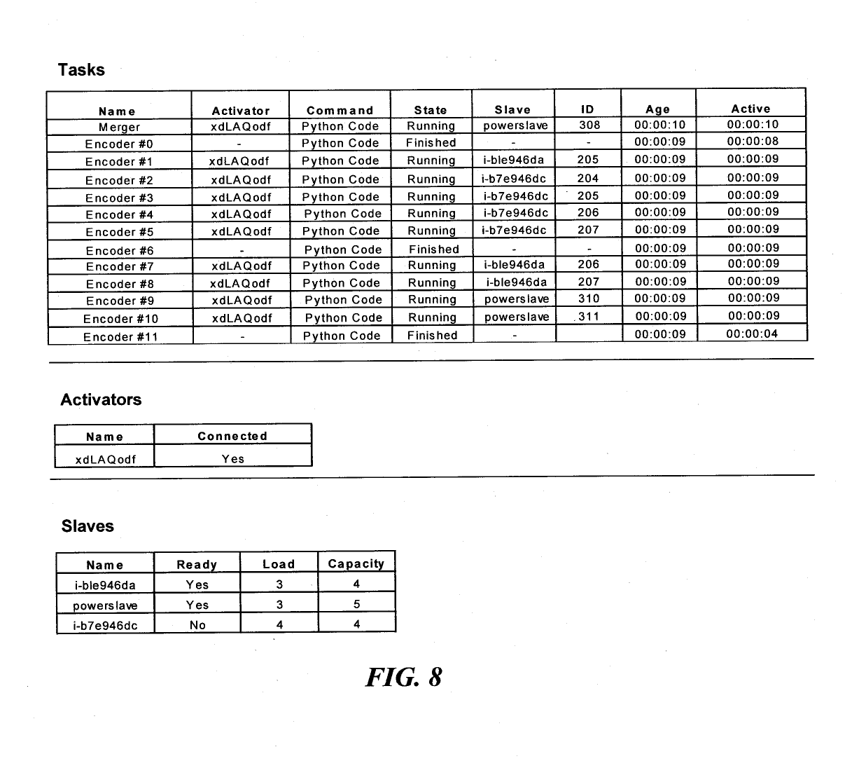

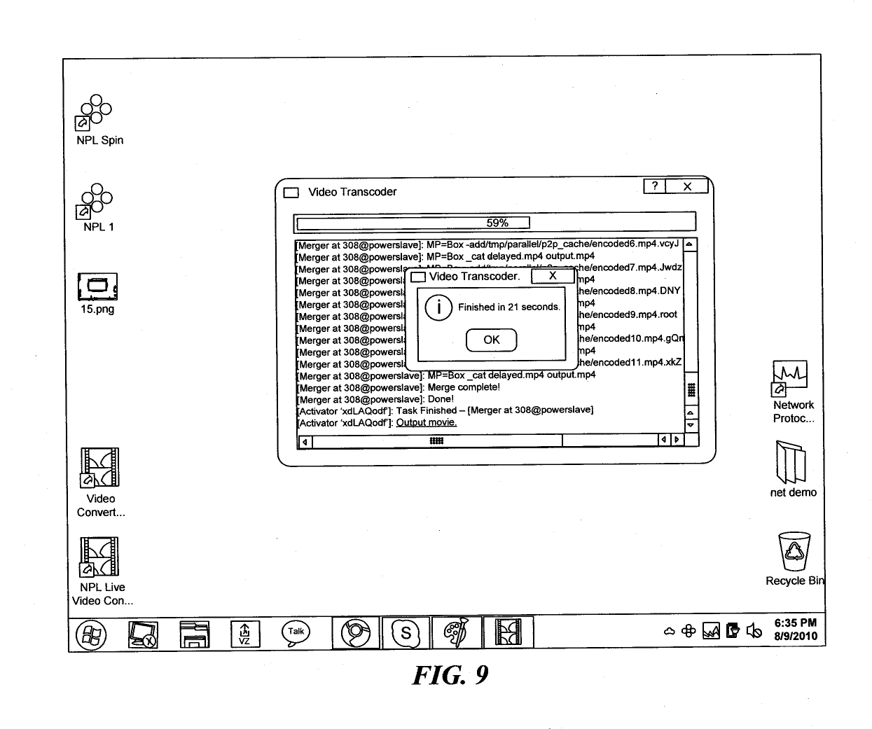

FIGS. 7-9 show a demonstration of an application powered by a distributed processing pipeline utilizing the network resources such as cloud servers to speed up the processing. The system has multiple nodes with software processing components suitable for various jobs such as decoding, processing, or encoding. The system has a node that can send the whole UI of a program as a layer. In one embodiment, an incoming video stream or video file from a content distribution network (CDN) needs to be transcoded. The system analyzes and decides whether the current device is capable for the task. If the current device is not capable, the experience agent makes a request to the system including a URL for the incoming stream or file. The system sets up the pipeline with multiple stages including receiving, decoding, processing, encoding, reassembly and streaming the result back to the CDN for delivery. The system manages the distribution of the processing by taking into account the available resource with appropriate software processing components and how fast the result needs to be, which can be accessed by the user fee in some cases. The system also set up a monitoring node that runs user interface (UI) for pipeline monitoring. The UI is transformed into a stream by the node and streamed to the end-device as a layer, which is fully supported by the remote GPU-powered pipeline. The experience agent receives the stream and the user can interact with the monitoring program. The processing speed can be as much as 40 times faster than using a netbook alone for the processing. In the system, the UI of the monitoring program is generated and sent as a layer that can be incorporated into a experience or stream. The processing pipeline is set up on the platform side.

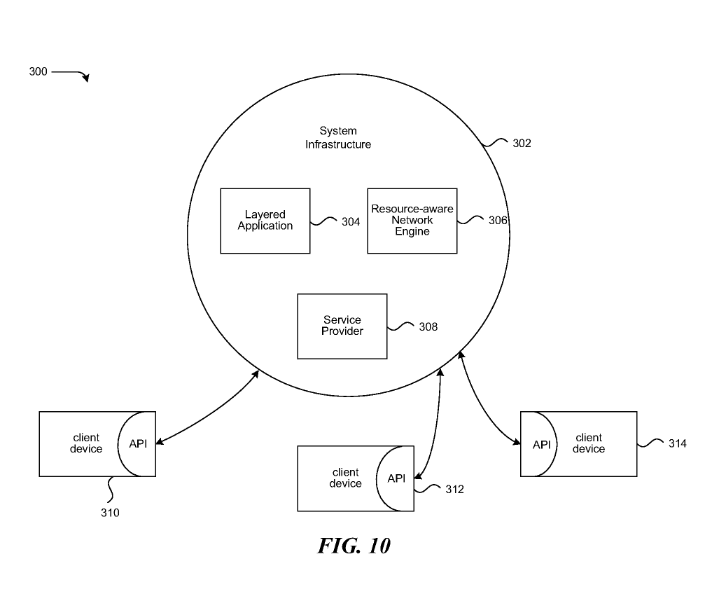

The description above illustrated in some detail how a specific application, an “experience,” can operate and how such an application can be generated as a composite of layers. FIG. 10 illustrates a block diagram of a system 300 for providing distributed execution or rendering of various layers associated with an application of any type suitable to layers. A system infrastructure 302 provides the framework within which a layered application 304 can be implemented. A layered application is defined as a composite of layers. Example layers could be video, audio, graphics, or data streams associate with other senses or operations. Each layer requires some computational action for creation.

With further reference to FIG. 10, the system infrastructure 302 further includes a resource-aware network engine 306 and one or more service providers 308. The system 300 includes a plurality of client devices 308, 310, and 321. The illustrated devices all expose an API defining the hardware and/or functionality available to the system infrastructure 302. In an initialization process or through any suitable mechanism, each client device and any service providers register with the system infrastructure 306 making known the available functionality. During execution of the layered application 304, the resource-aware network engine 306 can assign the computational task associated with a layer (e.g., execution or rendering) to a client device or service provider capable of performing the computational task.

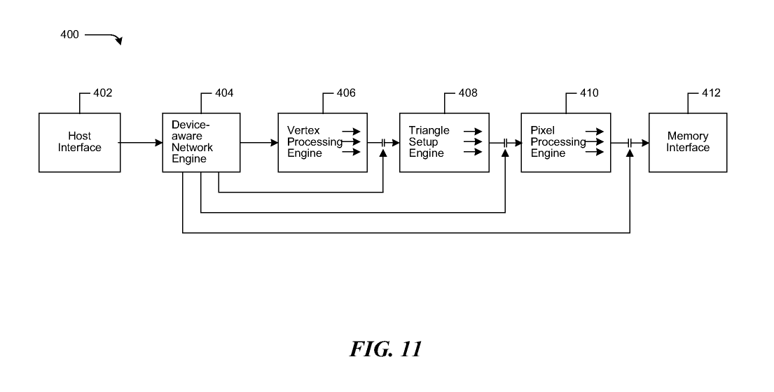

Another possible paradigm for distributing tasks is to distribute different stages of a processing pipeline, such as a graphics processing unit (GPU) pipeline. FIG. 11 illustrates a distributed GPU pipeline 400 and infrastructure enabling the pipeline to be distributed among geographically distributed devices. Similar to a traditional GPU pipeline, the distributed GPU pipeline 400 receives geometry information from a source, e.g. a CPU, as input and after processing provides an image as an output. The distributed GPU pipeline 400 includes a host interface 402, a device-aware network engine 404, a vertex processing engine 406, a triangle setup engine 408, a pixel processing engine 410, and a memory interface 412.

In one embodiment, operation of the standard GPU stages (i.e., the host interface 402, the vertex processing engine 406, the triangle setup engine 408, the pixel processing engine 410, and the memory interface 412) tracks the traditional GPU pipeline and will be well understood by those skilled in the art. In particular, many of the operations in these different stages are highly parallelized. The device-aware network engine 404 utilizes knowledge of the network and available device functionality to distribute different operations across service providers and/or client devices available through the system infrastructure. Thus parallel tasks from one stage can be assigned to multiple devices. Additionally, each different stage can be assigned to different devices. Thus the distribution of processing tasks can be in parallel across each stage of the pipeline, and/or divided serially among different stages of the pipeline.

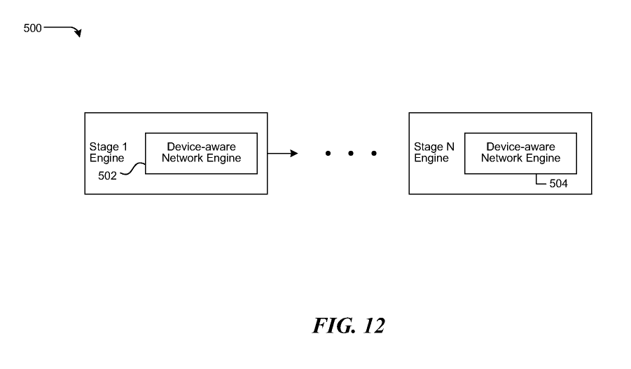

While the device-aware network engine may be a stand alone engine, distributed or centralized, as implied from the diagram of FIG. 11, it will be appreciated that other architectures can implement the device-aware network engine alternatively. FIG. 12 illustrates a block diagram of a multi-stage distributed processing pipeline 500 where a device-aware network engine is integrated within each processing stage. The distributed processing pipeline 500 could of course be a GPU pipeline, but it is contemplated that any processing pipeline can be amenable to the present teaching. The distributed processing pipeline 500 includes a plurality of processing engines stage 1 engine through stage N engine, where N is an integer greater than 1. In this embodiment, each processing engine includes a device-aware network engine such as device-aware network engines 502 and 504. Similar to the embodiments described above, the device-aware network engines are capable of distributing the various processing tasks of the N stages across client devices and available service providers, taking into consideration device hardware and exposed functionality, the nature of the processing task, as well as network characteristics. All of these decisions may be made dynamically, adjusting for the current situation of the network and devices.

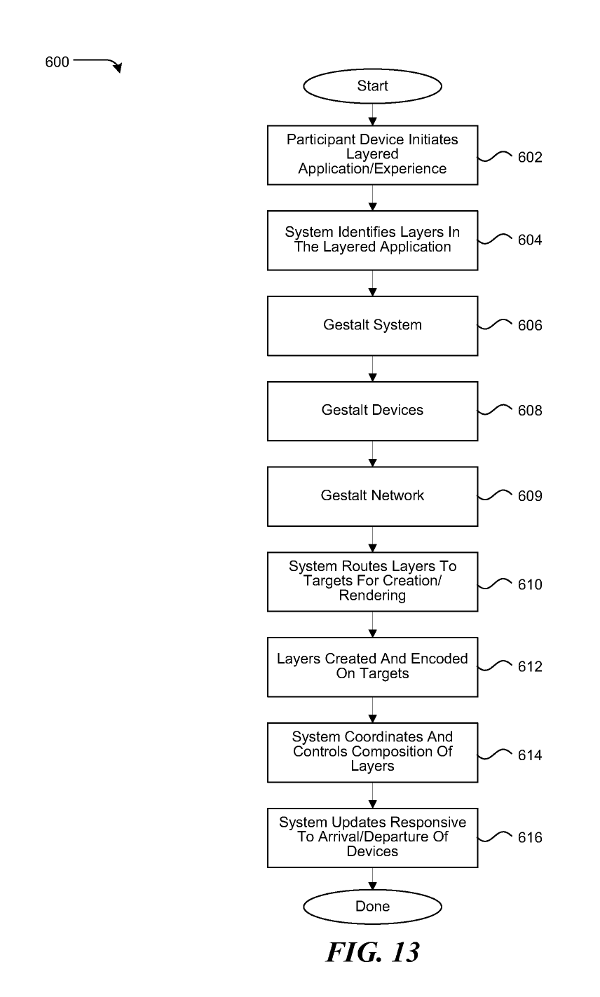

FIG. 13 is a flow chart of a method 600 for distributed creation of a layered application or experience. In a step 602, the layered application or experience is initiated. The initiation may take place at a participant device, and in some embodiments a basic layer is already instantiated or immediately available for creation on the participant device. For example, a graphical layer with an initiate button may be available on the device, or a graphical user interface layer may immediately be launched on the participant device, while another layer or a portion of the original layer may invite and include other participant devices.

In a step 604, the system identifies and/or defines the layers required for implementation of the layered application initiated in step 602. The layered application may have a fixed number of layers, or the number of layers may evolve during creation of the layered application. Accordingly, step 604 may include monitoring to continually update for layer evolution.

In some embodiments, the layers of the layered application are defined by regions. For example, the experience may contain one motion-intensive region displaying a video clip and another motion-intensive region displaying a flash video. The motion in another region of the layered application may be less intensive. In this case, the layers can be identified and separated by the multiple regions with different levels of motion intensities. One of the layers may include full-motion video enclosed within one of the regions.

If necessary step 606 gestalts the system. The “gestalt” operation determines characteristics of the entity it is operating on. In this case, to gestalt the system could include identifying available servers, and their hardware functionality and operating system. A step 608 gestalts the participant devices, identifying features such as operating system, hardware capability, API, etc. A step 609 gestalts the network, identifying characteristics such as instantaneous and average bandwidth, jitter, and latency. Of course, the gestalt steps may be done once at the beginning of operation, or may be periodically/continuously performed and the results taken into consideration during distribution of the layers for application creation.

In a step 610, the system routes and distributes the various layers for creation at target devices. The target devices may be any electronic devices contain processing units such as CPUs and/or GPUs. For example, Some of the target devices may be servers in a cloud computing infrastructure. The CPUs or GPUs of the servers may be highly specialized processing units for computing intensive tasks. Some of the target devices may be personal electronic devices from clients, participants or users. The personal electronic devices may have relatively thin computing power. But the CPUs and/or GPUs may be sufficient enough to handle certain processing tasks so that some light-weight tasks can be routed to these devices. For example, GPU intensive layers may be routed to a server with significant amount of GPU computing power provided by one or many advanced manycore GPUs, while layers which require little processing power may be routed to suitable participant devices. For example, a layer having full-motion video enclosed in a region may be routed to a server with significant GPU power. A layer having less motion may be routed to a thin server, or even directly to a user device that has enough processing power on the CPU or GPU to process the layer. Additionally, the system can take into consideration many factors include device, network, and system gestalt. It is even possible that an application or a participant may be able to have control over where a layer is created. In a step 612, the distributed layers are created on the target devices, the result being encoded (e.g., via a sentio codec) and available as a data stream. In a step 614, the system the coordinates and controls composition of the encoded layers, determining where to merge and coordinating application delivery. In a step 616, the system monitors for new devices and for departure of active devices, appropriately altering layer routing as necessary and desirable.

In some embodiments, there exist two different types of nodes or devices. One type of nodes are general-purpose computing nodes. These CPU or GPU-enabled nodes support one or more APIs such as python language, Open CL or CUDA. The nodes may be preloaded with software processing components or may load them dynamically from a common node. The other type of nodes are application- or device-specific pipelines. Some devices are uniquely qualified for doing certain task or stages of the pipeline, while at the same time they may be not so good at doing general-purpose computing. For example, many mobile devices have a limited battery life so using them for participating in 3rd party computations may result in bad overall experience due to the fast battery drain. But at the same time, they may have hardware elements that do certain operations with low power requirements such as audio or video encoding or decoding. Or they may have a unique source of data (such as photos or videos) or sensors whose data-generation and streaming tasks are not intensive for pipeline processing. In order to maintain a low latency, the system identifies the software processing components of each node, its characteristics, and monitors network connection in real-time in all communications. The system may reroute the execution of the processing in realtime based on the network conditions.

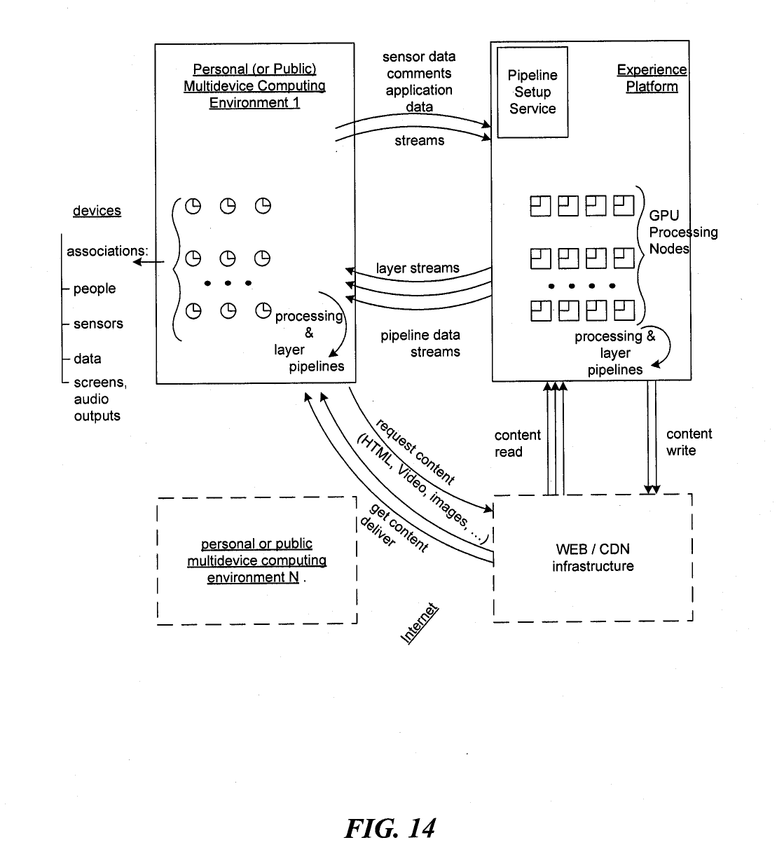

FIG. 14 is a high level overview of the system. There are communications between each other when using distributed pipelines to enhance experience by adding additional layers of experience on “weak” devices, or speeding up processing application by splitting GPU processing pipeline. The pipeline data streams are the binary data that's being sent for processing which can be any data. The layer streams are the streams that represent layers that can typically be rendered by devices (such as video streams ready for decode and playback), which represent a layer in an experience. Pipeline can not only use GPU processing nodes hosted in an experience platform, but also utilize devices in a personal multi-device environment. There is a pipeline setup service that manages the setup of the pipeline. The pipeline setup service is for nodes hosted in an experience platform and in a personal environment. Implementation can vary from simple centralized server to complex p2p setup or overlay network. Contents from a CDN or standard web infrastructure can be plugged in to processing pipelines.

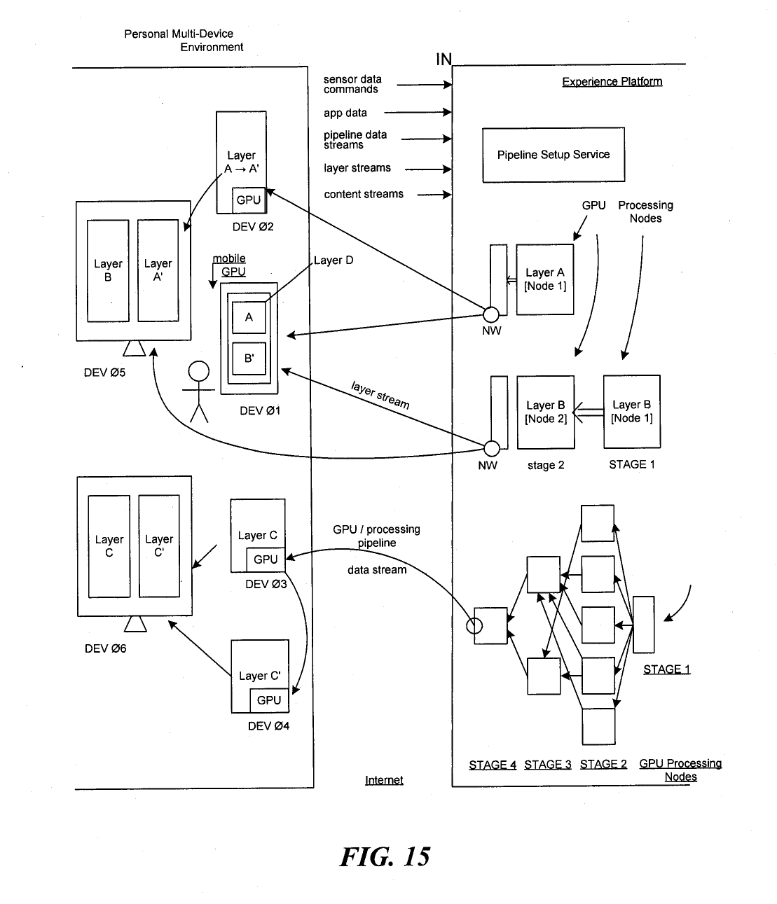

FIG. 15 shows a few examples of distributed GPU pipelines in action. One is a layer-based distributed pipeline (layer A and layer B). Another is a generic processing pipeline with multiple stages and parallelization. FIG. 15 shows that devices in the personal computing environment can continue processing the pipeline and can process and restream layers. For example, stage 1 nodes can take in all the inputs listed (where the 5 incoming arrows are) or they can just start generating layers or intermediate processing based on their components and data. The rectangle with a circle to the left of layer stream generators for layers A and B represents transforming GPU computations to actual layer, encoding the layer and sending it (with a low latency) to next nodes. The system splits processing by layers and does general processing pipeline. The components may be transformation to layer or may be an arbitrary data stream. The data stream may be low-level GPU data and commands. In some embodiments, the data stream may be data specific to certain software or hardware processing component as provided by the device or sensor data.

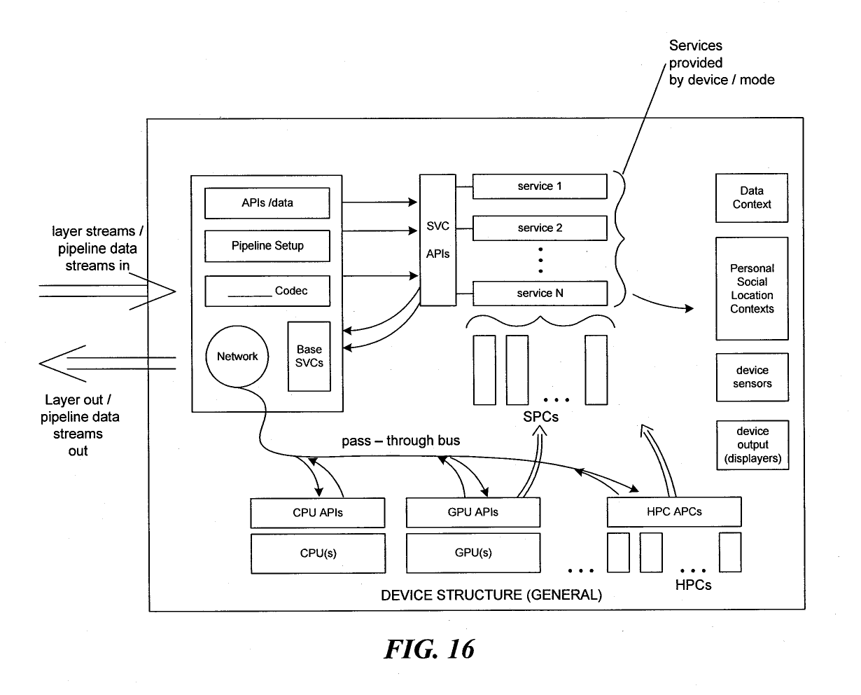

FIG. 16 shows a general structure of device or GPU processing unit. SPC is software processing component (such as rendering an effect or gesture recognition or picture upconversion). HPC is the hardware processing component (any processing function enabled by hardware chip such as video encoding or decoding). In some embodiments, there may be one or more CPUs and multiple GPUs within a device. Services and service APIs are high level services provided by device, such as “source of photo”, “image enhancement”, “Open CL execution”, “gesture recognition” or “transcoding”. These software components require and their action is enhanced by multiple sources of data present on device, such as images, textures, 3d models, any data in general useful for processing or creating a layer. Sources of data also includes personal, social and location contexts, such who is the owner of the device, whether owner is holding this device, where it is relative to other devices of the owner or to other people's devices, whether there is owners' friends devices nearby, and whether they are on. These types of attributes are necessary to enhance experience. Real-time knowledge about the network and codec such as sentio codec is needed for quality of experience (QoE). Pipeline setup agent organizes the device in the pipeline. Device has sensors and outputs attached to it. The sensor and outputs information may be used to define the device's role in the pipeline. For example, if a device needs to be displaying hi-resolution HD content and only has resources to do that, heavy processing task won't be assigned to the device. Pass-through channel is used for low-level pipeline splitting. Low-level pipeline splitting enables the feeding of the pipeline data and raw GPU data and API commands directly into GPU without higher-level application-specific service APIs. The pass-through can also support direct access to CPU and HPCs.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A method for rendering a layered participant experience on a group of servers and participant devices, the method comprising steps of:
initiating one or more participant experiences;
defining layers required for implementation of the layered participant experience, each of the layers comprising one or more of the participant experiences;
routing each of the layers to one of the plurality of the servers and the participant devices for rendering;
rendering and encoding each of the layers on one of the plurality of the servers and the participant devices into data streams; and
coordinating and controlling the combination of the data streams into a layered participant experience.

2. The method of claim 1, further comprising a step of:
incorporating an available layer of participant experience.

3. The method of claim 1, further comprising a step of:
monitoring and updating the number of the layers required for implementation of the layered participant experience.

4. The method of claim 1, further comprising a step of:
dividing one or more participant experiences into a plurality of regions, wherein at least one of the layers includes full-motion video enclosed within one of the plurality of regions.

5. The method of claim 4, wherein the defining step further comprises defining layers required for implementation of the layered participant experience based on the regions enclosing full-motion video, each of the layers comprising one or more of the participant experiences.

6. The method of claim 1, wherein the initiating step further comprises initiating one or more participant experiences on at least one of the participant devices.

7. The method of claim 1, further comprising a step of:
determining hardware and software functionalities of each of the servers.

8. The method of claim 1, further comprising a step of:
determining hardware and software functionalities of each of the participant devices.

9. The method of claim 1, wherein the servers and participant devices are inter-connected by a network.

10. The method of claim 9, further comprising a step of:
determining and monitoring the bandwidth, jitter, and latency information of the network.

11. The method of claim 1, further comprising a step of:
deciding a routing strategy distributing the layers to the plurality of servers or participant devices based on hardware and software functionalities of the servers and participant devices.

12. The method of claim 11, wherein the routing strategy is further based on the bandwidth, jitter and latency information of the network.

13. The method of claim 1, wherein the rendering and encoding step further comprises rendering and encoding the layers on one or more graphics processing units (GPUs) of the servers or the participant devices into data streams.

13. A distributed processing pipeline utilizing a plurality of processing units inter-connected via a network, the pipeline comprising:
a host interface receiving a processing task;
a device-aware network engine operative to receive the processing task and to divide the processing task into a plurality of parallel tasks;
a distributed processing engine comprising at least one of the processing units, each processing unit being operative to receive and process one or more of the parallel tasks; and
wherein the device-aware network engine is operative to assign the processing units to the distributed processing engine based on the processing task, the status of the network, and the functionalities of the processing units.

14. The distributed processing pipeline of claim 13, wherein the distributed processing engine comprises:
a vertex processing engine comprising at least one of the process units, each process unit being operative to receive and process one or more of the parallel tasks;
a triangle setup engine comprising at least one of the process units, each process unit being operative to receive and process one or more of the parallel tasks; and
a pixel processing engine comprising at least one of the process units, each process unit being operative to receive and process one or more of the parallel tasks.

15. The distributed processing pipeline of claim 13, wherein at least one of the processing units is a graphics processing unit (GPU).

16. The distributed processing pipeline of claim 13, wherein at least one of the processing units is embedded in a personal electronic device.

17. The distributed processing pipeline of claim 13, wherein at least one of the processing units is disposed in a server of a cloud computing infrastructure.

18. The distributed processing pipeline of claim 13, further comprising a memory interface operative to receive and store information and accessible by the device-aware network engine.

19. The distributed processing pipeline of claim 14, wherein the device-aware network engine comprises a plurality of device-aware network sub-engines and each sub-engine corresponds to one of the vertex processing engine, the triangle setup engine, and the pixel processing engine.

20. The distributed processing pipeline of claim 14,
wherein the device-aware network engine is operative to divide the processing task into a plurality of parallel vertex tasks and to assign at least one of the process units into the vertex processing engine; and
wherein each process unit of the vertex processing engine is operative to receive and process at least one of the parallel vertex tasks and to return the vertex results to the memory interface.

21. The distributed processing pipeline of claim 20,
wherein the device-aware network engine is operative to combine the vertex results and generate a plurality of parallel triangle tasks and to assign at least one of the process units into the triangle setup engine; and
wherein each process unit of the triangle setup engine is operative to receive and process at least one of the parallel triangle tasks and to return the triangle result to the memory interface.

22. The distributed processing pipeline of claim 21,
wherein the device-aware network engine is operative to combine the triangle result and generate a plurality of parallel pixel tasks and to assign at least one of the process units into the pixel processing engine; and
wherein each process unit of the pixel processing engine is operative to receive and process at least one of the parallel pixel tasks and to return the pixel results to the memory interface.

23. The distributed processing pipeline of claim 14, wherein the device-aware network engine is operative to dynamically assign the process units to the vertex processing engine, the triangle setup engine, and the pixel processing engine based on the processing task, the status of the network, and the functionalities of the process units at all stages of the processing.

24. A method of process a task utilizing a plurality of graphics processing units (CPUs) inter-connected via a network, the method comprising:
receiving a processing task;
dividing the processing task into a plurality of parallel vertex tasks;
assigning at least one of the CPUs to a vertex processing engine based on the processing task, the status of the network, and the functionality of the GPUs and sending the parallel vertex tasks to the GPUs of the vertex processing engine;
receiving and combining vertex results from the GPUs of the vertex processing engine and generating a plurality of parallel triangle tasks;
assigning at least one of the GPUs to a triangle setup engine based on the processing task, the status of the network, and the functionality of the GPUs and sending the parallel triangle tasks to the GPUs of the triangle setup engine;
receiving and combining triangle results from the GPUs of the triangle setup engine and generating a plurality of parallel pixel tasks;
assigning at least one of the GPUs to a pixel processing engine based on the processing task, the status of the network, and the functionality of the GPUs and sending the parallel pixel tasks to the GPUs of the pixel processing engine; and
receiving and combining pixel results from the GPUs of the pixel processing engine.
